(19) United States
(12) Patent Application Publication
(10) Pub. No.: US 2025/0197128 A1
(43) Pub. Date: Jun. 19, 2025

(54) DEVICE AND METHOD FOR FORMING GROUPS OF INDIVIDUAL PRODUCTS

(71) Applicant: OPTIMA nonwovens GmbH, Schwäbisch Hall (DE)

(72) Inventor: Georg Pfeifer, Schwäbisch Hall (DE)

(73) Assignee: OPTIMA nonwovens GmbH, Schwäbisch Hall (DE)

(21) Appl. No.: 18/860,673

(22) PCT Filed: Feb. 2, 2023
(86) PCT No.: PCT/EP2023/052517

§ 371 Date: Oct. 27, 2024

(30) Foreign Application Priority Data
Apr. 27, 2022 (DE) 102022204080.5

(51) Int. Cl. B65G 47/08

(52) U.S. Cl. CPC B65G 47/08; B65G 2201/0232

(57) ABSTRACT

The invention relates to a device and to a method for forming groups of individual products (3), in particular of hygiene products such as diapers, panty liners, sanitary pads, wherein individual products (3) conveyed one behind the other in a product flow may be lined up next to one another inside the cassette (4), wherein a transport system (2) with a transport surface (21), with several transport elements (20) and with a control unit (22) is provided, wherein the control unit (22) is configured to control actuators on the transport surface (21) and/or on the transport elements (20), so that the transport elements (20) are movable relative to the transport surface (21) independently of one another and simultaneously in speed and/or position controlled manner, and wherein the cassette (4) is arranged on a first transport element (20) or is couplable to a first transport element (20) for a movement.

### TECHNICAL FIELD AND PRIOR ART

The invention relates to a device and to a method for forming groups of individual products. The invention relates in particular to a device and to a method for forming groups of hygiene products such as diapers, panty liners, sanitary pads, incontinence products, wet wipes, toilet paper, paper towel rolls or the like.

Products to be packaged are taken over from stock or from a manufacturing line, as a rule as individual products, and combined in a packaging unit comprising a packaging material and several individual products surrounded at least in regions by the packaging material. The individual products, a unit comprising several individual products, and/or the packaging unit, are suitably handled in one or more process steps, for example the individual products are turned, folded, checked, combined in stacks or in groups with several stacks, units comprising several individual products are conveyed to a packaging material, and the packaging material is sealed, labeled and printed, and packaging units are dispensed.

Various devices for forming groups are known. For example, a stacking device for forming stacks from individual products delivered one behind the other is known from EP1663823 B1, comprising a plurality of compartments moved along a closed route and into each of which a single product is inserted, wherein a stack of products is then ejected out of several adjacent compartments. A transfer device is known from EP1670706 B1 that receives singly delivered products inside pockets and conveys them to a stacking device with compartments. During conveying, the products receive a speed component in the direction of movement of the compartments, whereas they were decelerated to a standstill in their previous direction.

### OBJECT AND SOLUTION

It is an object of the invention to provide a device and a method for forming groups of individual products, in particular for forming groups of hygiene products such as diapers, panty liners, sanitary pads, incontinence products, wet wipes, toilet paper, paper towel rolls or the like, which have high flexibility.

This object is achieved by the device having the features of claim 1 and by the method having the features of claim 7. Further advantageous embodiments result from the dependent claims.

In accordance with a first aspect, a device is provided for forming groups, in particular for forming groups of hygiene products such as diapers, panty liners, sanitary pads, incontinence products, wet wipes, toilet paper, paper towel rolls or the like, comprising a cassette, wherein individual products conveyed one behind the other in a product flow may be lined up next to one another in the cassette, wherein the device comprises a transport system with a transport surface, with several transport elements and with a control unit, wherein the control unit is configured to control actuators on the transport surface and/or on the transport elements, so that the transport elements are movable relative to the transport surface independently of one another and simultaneously in controlled manner, and wherein the cassette is arranged on a first transport element or is couplable to a first transport element for a movement.

In accordance with a second aspect, a method is provided for forming groups of individual products, in particular for forming groups of hygiene products such as diapers, panty liners, sanitary pads, incontinence products, wet wipes, toilet paper, paper towel rolls or the like, wherein individual products conveyed one behind the other in a product flow are lined up next to one another in a cassette, wherein while and/or after receiving individual products the cassette is moved by a first transport element movable relative to a transport surface, and wherein the first transport element and the transport surface are parts of a transport system comprising the transport surface and several transport elements movable relative to the transport surface independently of one another and simultaneously in a speed and/or position controlled manner.

In connection with the terms “a” or “an” are generally used as the indefinite terms and not as “one” in the numerical sense. In particular, in an embodiment more than one cassette is provided and/or a cassette is couplable to more than one transport element for a movement.

The terms “first” and “second” are used here only to distinguish, and not to indicate any sequence. Similarly, the use of the term “first transport element” does not necessarily require the presence of further transport elements.

A transport system comprising a transport surface and transport elements movable relative thereto in a speed and/or position controlled manner is also referred to as a planar transport system. The transport surface is designed in an embodiment as a stator. The transport elements are movable with three degrees of freedom, in at least one plane parallel to the transport surface, for changing a position and an orientation. The transport system is designed in advantageous embodiments such that a movement of the transport elements relative to the transport surface is possible with six degrees of freedom. This ensures a particularly high flexibility. Movement of the transport elements relative to the transport surface is contactless or floating in some embodiments of the transport system. A corresponding transport system is for example known from DE102018209401 A1, to which reference is made here in full. The application is however not restricted to the use of a transport system known from DE102018209401 A1.

In an embodiment, the transport surface is arranged in a horizontal plane. Embodiments are however also conceivable in which a vertically arranged transport surface is provided alternatively or additionally.

In an embodiment, the cassette has compartments, wherein individual products are each receivable inside one compartment. In an embodiment, the cassette is fitted on a transport element. Alternatively or additionally, a separate mobile cassette with or without compartments for individual products is provided in a further embodiment, wherein the cassette is movable by one transport element or by several transport elements. The device has in an embodiment both transport elements with cassettes attached thereon and several separate cassettes which are movable by transport elements.

In an embodiment, the cassette is moved transversely for receiving individual products, in particular vertically to the direction of the product flow and synchronized to a conveying speed of the individual products, so that the individual products may be lined up next to one another inside the cassette. In the case of hygiene products with flat sides such as diapers, panty liners, sanitary pads, incontinence products and wet wipes, they are lined up such that the flat sides of the hygiene products are arranged adjoining one another or at least substantially parallel in advantageous embodiments.

In an embodiment, individual products with flat sides are conveyed in a product flow with their flat sides parallel to a horizontal surface and are received by a suitably oriented cassette, wherein the cassette is moved vertically to the horizontal surface for receiving and lining up individual products, and the individual products are stacked one above the other inside the cassette. In an embodiment, the cassette is swiveled about a horizontal axis after receiving is completed, and subsequently moved parallel to the horizontal surface. In an embodiment, the transport surface for the first transport element moving the cassette is arranged vertical to the horizontal surface.

In other embodiments, individual products with flat sides are conveyed in a product flow with their flat sides parallel to a horizontal surface and are turned before being lined up, so that their flat sides are arranged substantially vertical to the horizontal surface. The turned individual products are received by a suitably oriented cassette, wherein the cassette is moved parallel to the horizontal surface for receiving and lining up individual products and the individual products are stacked next to one another inside the cassette. After receiving is completed, the cassette may, depending on the embodiment, be moved in any direction to a subsequent station parallel to the horizontal surface. The horizontal surface acts here as a transport surface for the transport elements of the transport system.

The use of a transport system having several transport elements movable relative to the transport surface independently of one another and simultaneously in a speed and/or position controlled manner for a movement of the cassettes permits receiving of individual products at the cassette to be completely decoupled from the ejection of a group of individual products out of the cassette. In an embodiment, it is provided that the cassette is stationary for ejecting a group of lined-up individual products out of the cassette. In other embodiments, the cassette is moved in one transport direction synchronously with a belt conveyor for an ejection, wherein the group is pushed out transversely to the transport direction.

In an embodiment, the movement of the cassette is adaptable in individualized manner to a position of the product to be received in order to compensate for tolerances when receiving each individual product. For that purpose, in an embodiment a position of each individual product in the product flow is detected by a sensor unit and the transport element of the cassette is controlled accordingly by the control unit.

In an embodiment, the cassette is moved for receiving individual products such that the individual products are deceleratable at least substantially bump-free and/or jolt-free, preferably to a standstill, in a conveying direction of the product flow. Simultaneously, the cassette is moved transversely to the conveying direction, wherein the movement takes place such that the individual products are accelerated bump-free and/or jolt-free in the direction of movement of the cassette and transversely to the conveying direction of the product flow.

Alternatively or additionally, in an embodiment a transfer device is provided which is configured to receive single individual products delivered by the conveying unit one behind the other in its own longitudinal direction and to transfer them to the cassette. In an embodiment, the transfer device is designed in accordance with the transfer device known from EP1670706 B1, to which reference is made here in full. The transfer device comprises a plurality of pockets moved along a closed route and inside which singly delivered products are received, wherein the route is selected such that the products receive a speed component in the direction of movement of the cassette during conveying, whereas they were decelerated to a standstill in their previous direction.

The transfer device is arranged stationary in an embodiment. In another embodiment, the transfer device is arranged on the first transport element with the cassette. In other embodiments, a second transport element is provided on which the transfer device is arranged, wherein the transfer device is individually positionable relative to a conveying unit of the individual products and/or to the cassette in order to compensate for tolerances.

In an embodiment, it is provided that the first transport element and/or the second transport element are moved relative to the transport surface while receiving individual products from the conveying unit and/or while transferring individual products to the cassette.

In an embodiment of the device, two or more cassettes are provided for receiving the individual products at two or more receiving positions, wherein the cassettes are each arranged on a first transport element or are couplable to a first transport element for a movement, and wherein the control unit is configured to position a cassette for receiving the individual products at each of the transfer positions.

Accordingly, it is provided in an embodiment of the method that individual products conveyed by a conveying unit to two or more receiving positions are received, wherein a cassette is positioned at each of the receiving positions, and wherein the cassettes are moved by a first transport element movable relative to a transport surface while and/or after receiving the individual products.

The individual products are conveyed in an embodiment to the two or more receiving positions by a conveying unit comprising a distributor. In an embodiment, the individual products are conveyed by the conveying unit as far as the receiving position. In other embodiments, turning devices and/or transfer devices are provided between the conveying unit and the receiving position.

Depending on the embodiment, receiving at the different receiving positions takes place alternatingly or after a defined number of individual products has been reached. It is provided in an embodiment that initially a first cassette is filled, and products are conveyed to a second cassette after a required number of individual products in the first cassette has been reached. During conveying of individual products to the second cassette, the first cassette is moved away in an embodiment. It is provided in an embodiment that the group of individual products in the first cassette is ejected as a stack out of the cassette and transferred to a following transport system. The emptied first cassette is then suitably positioned again in an embodiment, so that after a required number of individual products in the second cassette has been reached, products can again be conveyed to the first cassette by the conveying unit. In another embodiment, further cassettes are provided, so that after the first cassette has been moved away a third cassette is positioned for receiving individual products from the conveying unit.

The groups formed in the two or more cassettes may, depending on specific use, be treated identically or differently in a subsequent process sequence.

In an embodiment, it is provided that a receiving area of the cassette is limited by walls, wherein at least one wall is movably mounted in order to vary a cassette size. In an embodiment, the control unit is configured to operate a third transport element to perform a movement, by which the movable wall is adjustable.

Alternatively or additionally, it is provided in an embodiment that a group of individual products is arranged between two transport elements, and the group is compressed by an opposing movement of the transport elements. The group may here be arranged on a transport element or on another surface.

In an embodiment, the control unit is further configured to move the cassette such that individual products are receivable in two or more planes at the cassette. In an embodiment, a transport system is provided with two transport surfaces arranged vertical to one another. The cassette is in an embodiment initially adjusted parallel to a horizontally arranged transport surface for receiving a first group. After receiving the first group, the cassette is moved parallel to a vertically arranged transport surface and thus positioned for receiving a second group in a second plane.

### BRIEF DESCRIPTION OF THE DRAWINGS

Further advantages and aspects of the invention can be derived from the claims and the description of examples of the invention that are explained in the following referring to the schematic figures. The drawing shows in:

FIG. 1 a first embodiment of a device for forming groups of individual products

FIG. 2 a second embodiment of a device for forming groups of individual products

FIG. 3 a process step for aligning products;

FIG. 4 a process step for compacting a stack of products;

FIG. 5 a third embodiment of a device for forming groups of individual products.

### DETAILED DESCRIPTION OF THE EXAMPLES

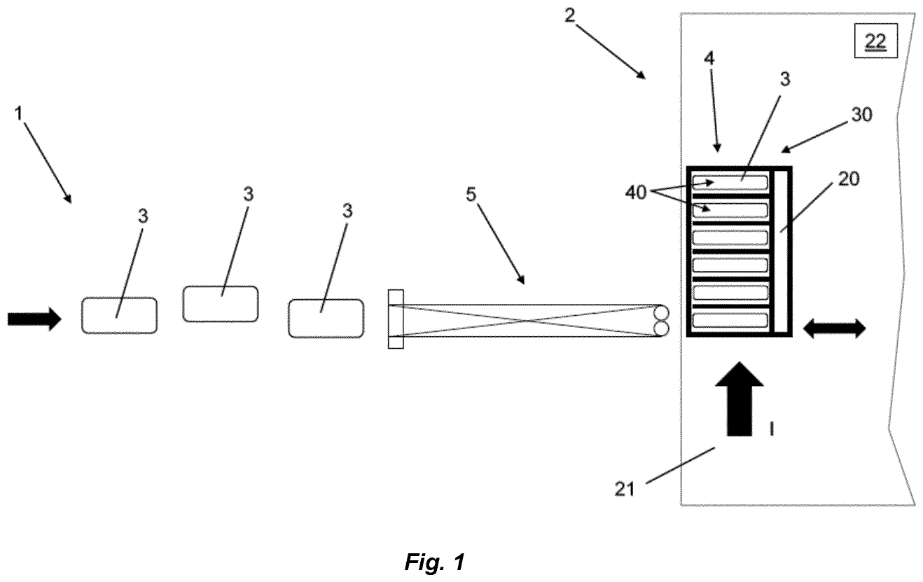

FIG. 1 shows schematically, in a plan view, a first embodiment of a device 1 for forming groups of individual products 3. The device 1 comprises a transport system 2 with a transport surface 21, with several transport elements 20 (albeit FIG. 1 shows only one transport element 20), and with a control unit 22. The transport system 2 is designed such that the transport elements 20 are movable relative to the transport surface 21 with at least three degrees of freedom, preferably with six degrees of freedom, in a plane parallel to the transport surface 21. The control unit 22 is for that purpose configured to operate actuators, not shown, on the transport surface 21 and/or on the transport elements 20, so that the transport elements 20 are movable relative to the transport surface 21 independently of one another and simultaneously in a speed and/or position controlled manner.

The device 1 comprises a conveying unit, not shown, for example a belt conveyor, by which a product flow of individual products 3 arranged one behind the other is conveyed in a conveying direction shown by an arrow.

The device 1 further comprises a cassette 4, wherein individual products 3 conveyed one behind the other in a product flow by the conveying unit may be lined up next to one another inside the cassette 4. The cassette 4 shown comprises a plurality of compartments 40, wherein an individual product 3 is receivable inside each compartment 40. The group of individual products 3 lined up inside the cassette 4 is also referred to as a stack 30.

In the example shown, the cassette 4 is arranged on a transport element 20 and is movable with the transport element 20.

The individual products 3 are conveyed in a product flow in a first alignment, in a conveying direction indicated schematically by an arrow, wherein the individual products 3 have flat sides and the flat sides are arranged parallel to a horizontal base surface in the product flow. In the example shown, a stationarily arranged turning device 5 is further provided, by which an orientation of the individual products 3 is changed, so that the flat sides are vertically aligned.

The cassette 4 is movable relative to the turning device 5 by the transport element 20 in a direction I shown by an arrow, in order to position each compartment 40 opposite the turning device 5 to receive an individual product 3. In an alternative embodiment, a turning device 5 is dispensed with.

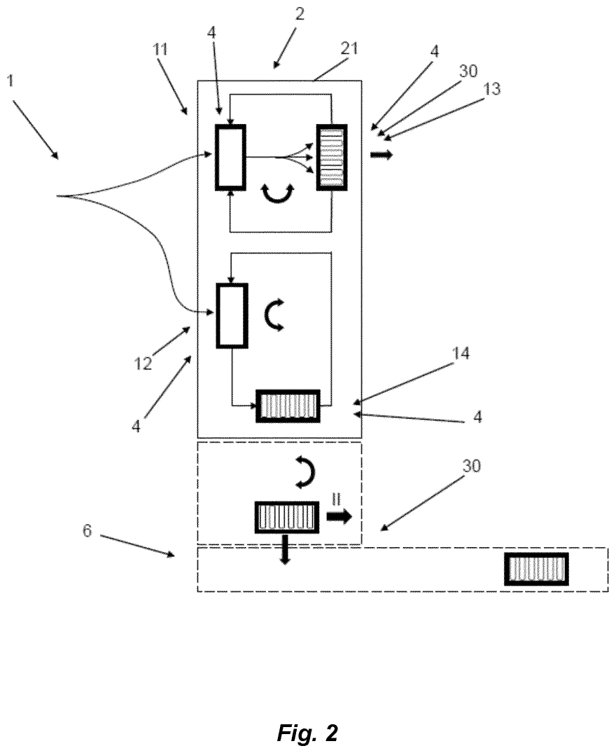

As indicated schematically by a double arrow in FIG. 2, the cassette 4 is in the example shown also movable relative to the turning device 5 in the conveying direction of the individual products 3 by the transport element 20 when receiving individual products 3. The cassette 4 is moved such that the individual products are decelerated bump-free and/or jolt-free, preferably to a standstill, in the conveying direction of the product flow. Simultaneously, the individual products receive a movement component in the direction I of the cassette 4 while being received.

In an embodiment, weighing takes place when individual products 3 are received. In particular, in an embodiment a weight of an individual product received by the transport element 20 is determined from a setting force for controlling the transport surface 21 for the transport element 20. Weighing while receiving individual products 3 allows irregularities to be detected at an early stage. In an embodiment, an associated transport element 20 is subjected to a manually or automatically performed check if an irregularity occurs.

FIG. 2 shows schematically, in a plan view, a device 1 for forming groups, wherein several receiving positions 11, 12 are provided to which individual products, not shown in FIG. 2, are each conveyed by a suitable conveying unit and if necessary a turning device or the like.

The device 1 according to FIG. 2 comprises several cassettes 4 which are each positionable in a receiving position 11, 12 for receiving the individual products. The cassettes 4 are movable relative to the transport surface 21 of the transport system 2 by transport elements, not shown in FIG. 2, of a transport system 2, independently of one another and simultaneously in a speed and/or position controlled manner.

In the embodiment according to FIG. 2, it is provided that a cassette 4 with a stack 30 is moved out of a first receiving position 11 into a first transfer position 13. The movement takes place for example along a linear, one-dimensional distance without any change in an orientation of the cassette 4. At the transfer position 13, a stack 30 lined up inside the cassette 4 can be ejected. Alternatively, the stack 30 inside the cassette 4 can be transported further by the transport element, not shown in FIG. 2, to a subsequent process. Simultaneously with the movement of the cassette 4 with the stack 30 out of the first receiving position 11 into the first transfer position 13, an empty cassette is positioned at the receiving position 11. Alternatively, the moved away cassette 4 is repositioned at the transfer position 13 after ejection of the stack 30.

It is further provided in the embodiment according to FIG. 2 that a further cassette 4 with a stack 30 is moved out of a second receiving position 12 into a second transfer position 14, wherein the cassette 4 is shifted 90° during the movement in the second transfer position 14. In the example shown, the cassette 4 at the second transfer position 14 is optionally shifted 180°—as shown schematically by an arrow—in addition before ejection of the stack 30. The stack 3 may then be moved away by a further transport element or by another transport system, for example by a belt conveyor 6. It is provided in the example shown that the cassette 4 with the stack 30 is moved synchronously with the belt conveyor 6 in its conveying direction II for transfer of the stack to the belt conveyor 6.

In an embodiment, the individual products are conveyed alternatingly, by a conveying unit indicated only schematically in FIG. 2, to the two receiving positions 11, 12.

It is provided in an embodiment that initially a first cassette 4 is filled at the first receiving position 11, and after a required number of individual products has been reached in the first cassette 4, products are conveyed to a second cassette 4 at the second receiving position 12. During conveying of the individual products to the second cassette 4, a first cassette 4 is moved away to the first transfer position 13. As shown schematically by an arrow, at the first transfer position 13 a group of individual products lined up in the first cassette 4 is ejected as a stack 30 out of the cassette 4. Simultaneously, a further cassette 4 is positioned at the first receiving position 11.

During receiving of the products inside the cassette 4, the cassette 4 is in an embodiment moved in the conveying direction of the product flow of individual products in order to compensate for a production-related shift between the individual products 3 in the product flow, in an individualized manner for each individual product 3.

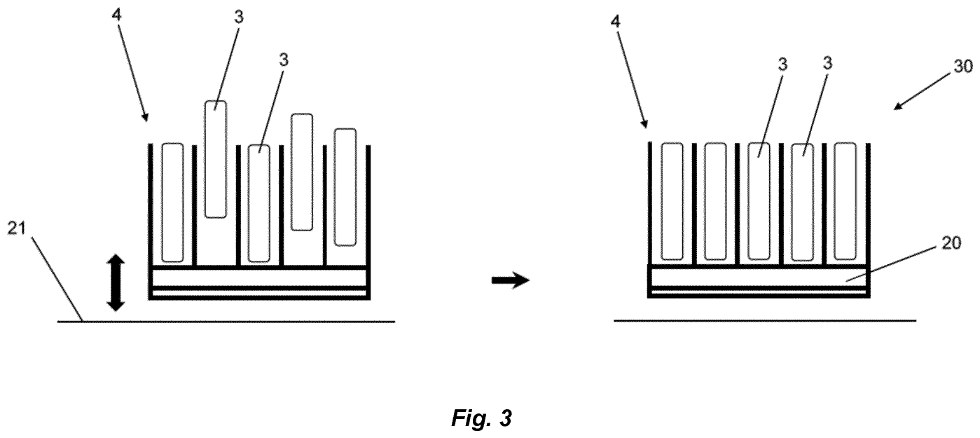

In another embodiment, no movement of the transport elements 20 in the conveying direction of the individual products 3 takes place for compensating a production-related shift between the individual products 3 in the product flow. If an alignment of the individual products 3 is necessary, this can take place in a subsequent process step, as shown schematically in FIG. 3.

FIG. 3 shows schematically an alignment of a stack 30 of individual products 3 lined up in a cassette 4. The individual products 3 are initially arranged without any order inside the cassette 4. The cassette 4 is arranged on a transport element 20 and is moved back and forth relative to the transport surface 21 by the transport element 20, as shown schematically by an arrow, so that the individual products 3 with their downward-facing ends are aligned with a floor of the cassette 4. Depending on the embodiment, the movement takes place vertically to the transport surface 21 and/or with another direction component.

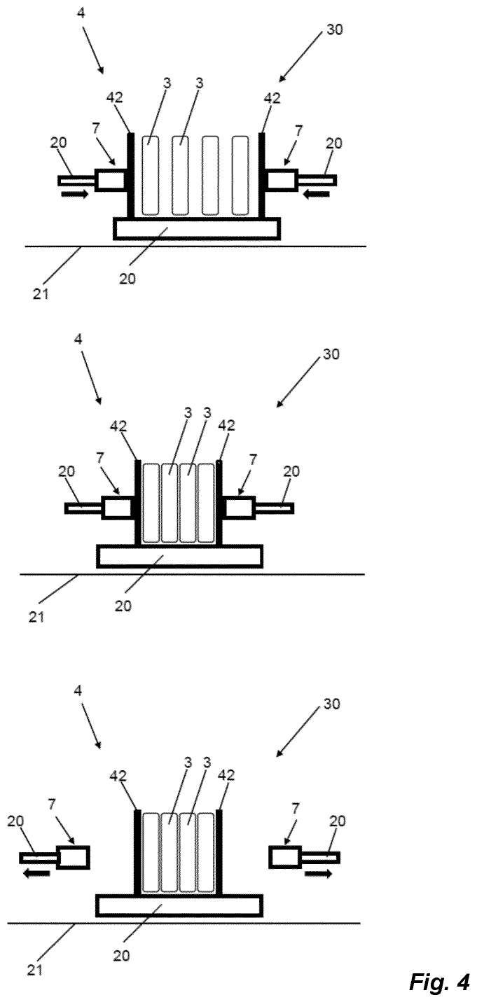

FIG. 4 shows schematically a compaction or compression of a stack 30 of individual products 3 lined up in a cassette 4. The cassette 4 is arranged on the transport element 20. The cassette 4 has two movable walls 42 arranged at opposite ends. For compacting the stack 30, the two walls 42 are moved towards one another. In an alternative embodiment, a movable wall and a stationary wall are provided.

Two plungers 7 are provided for movement of the walls 42. In an embodiment, the plungers 7 are provided stationary at a station, wherein the transport element 20 with the stack 30 of individual products 3 is moved between the plungers 7 for compacting. In the embodiment shown, the plungers 7 are each provided on one transport element 20, wherein the transport elements 20 are moved relative to one another to compact the stack 30.

In the example shown, the transport elements 20 with the plungers 7 are arranged floating above the transport surface 21 and movable relative to the transport surface 21. In an alternative embodiment, a second transport surface is provided which is arranged vertical to the transport surface 21 shown, wherein the transport elements 20 with the plungers 7 are movable relative to the second transport surface. In yet another embodiment, the plungers 7 are attached to a transport element 20 by mounting structures, so that a distance between the transport elements 20 of the plungers 7 and the transport surface 21 may be reduced while maintaining the height of the plungers 7.

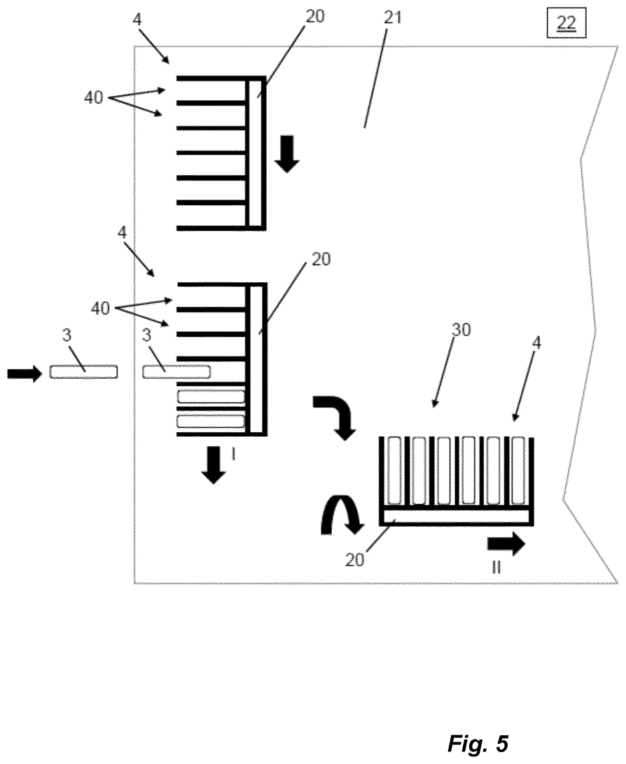

FIG. 5 shows schematically, in a side view, a further embodiment of a device 1 for forming groups of individual products 3, comprising a transfer system 2 with a transport surface 21, with several transport elements 20 and with a control unit 22. Unlike in the embodiment according to FIG. 1, the transport surface 21 of the transport system 2 is arranged vertical, wherein the transport elements 20 are movable in a plane parallel to the transport surface 21 with at least three degrees of freedom, preferably with six degrees of freedom.

The device comprises a plurality of cassettes 4, which in the example shown are each attached to transport elements 20 for movement with the transport element 20. The cassettes 4 shown have compartments 40 for one individual product each.

As shown schematically at bottom left in FIG. 5, individual products 3 are conveyed in a product flow in a conveying direction shown by an arrow and received inside a correspondingly positioned cassette 4, in particular inside a compartment 40 of the cassette 4. The cassette 4 is moved, synchronized with the conveying speed of the individual products 3, transversely in a first direction I, in particular vertically to the conveying direction of the individual products 3, so that each compartment 40 is suitably positioned for receiving an individual product 3. Once a required number of individual products 3 has been received inside the cassette 4, the cassette 4 is moved away. In the example shown, the cassette 4 is for that purpose swiveled about an axis vertical to the transport surface 21, as indicated schematically by an arrow, and then moved away in a second direction II vertical to the first direction I.

As set forth above, the transport elements 4 are in an embodiment movable relative to the transport surface 21 with six degrees of freedom. In an embodiment, the cassette is swiveled about a horizontal axis arranged parallel to the transport surface 21 for ejection of a stack 30 received inside the cassette 4, as shown schematically by an arrow in FIG. 5.

The embodiments shown are only by way of example, and numerous variants are conceivable for use of a planar transport system 2 in a device and/or a method for forming groups of individual products.

1. A device is provided for forming groups of individual products, in particular for forming groups of hygiene products such as diapers, panty liners, sanitary pads, incontinence products, wet wipes, toilet paper, paper towel rolls or the like, comprising a cassette, wherein individual products conveyed one behind the other in a product flow may be lined up next to one another inside the cassette, wherein the device comprises a transport system with a transport surface, with several transport elements and with a control unit, wherein the control unit is configured to control actuators on the transport surface and/or on the transport elements, so that the transport elements are movable relative to the transport surface independently of one another and simultaneously in speed and/or position controlled manner, and wherein the cassette is arranged on a first transport element or is couplable to a first transport element for a movement.

2. The device according to claim 1, wherein the control unit is configured to move the cassette relative to the transport surface during receiving of individual products in such a way that the individual products are deceleratable bump-free and/or jolt-free in a conveying direction of the product flow.

3. The device according to claim 1, wherein a transfer device is provided which is configured to receive single individual products delivered by the conveying unit one behind the other in its own longitudinal direction and to transfer them to the cassette, wherein in particular the transfer device is provided on a second transport element, and wherein in particular the control unit is further configured to move the first transport element and/or the second transport element relative to the transport surface during receiving of individual products from the conveying unit and/or during transfer of individual products to the cassette.

4. The device according to claim 1, wherein two or more cassettes are provided for receiving individual products at two or more receiving positions, wherein the cassettes are each arranged on a first transport element or are couplable to a first transport element for a movement, and wherein the control unit is configured to position a cassette for receiving the individual products at each of the transfer positions.

5. The device according to claim 1, wherein a receiving area of the cassette is limited by walls, wherein at least one wall is movably mounted in order to vary a cassette size, and wherein in particular the control unit is configured to operate a third transport element to perform a movement, by which the movable wall is adjustable.

6. The device according to claim 1, wherein the control unit is configured to move the cassette such that individual products are receivable in two or more planes at the cassette.

7. A method for forming groups of individual products, in particular for forming groups of hygiene products such as diapers, panty liners, sanitary pads, incontinence products, wet wipes, toilet paper, paper towel rolls or the like, wherein individual products conveyed one behind the other in a product flow are lined up next to one another in a cassette, wherein while and/or after receiving individual products the cassette is moved by a first transport element movable relative to a transport surface, and wherein the first transport element and the transport surface are parts of a transport system comprising the transport surface and several transport elements movable relative to the transport surface independently of one another and simultaneously in a speed and/or position controlled manner.

8. The method according to claim 7, wherein the cassette is moved relative to the transport surface while receiving of individual products in such a way that the individual products are decelerated bump-free and/or jolt-free in a conveying direction of the product flow.

9. The method according to claim 7 wherein single individual products delivered one behind the other in their own longitudinal direction are received by a transfer device and transferred to the cassette, wherein in particular the transfer device is provided on a second transport element of the transport system, and wherein in particular the first transport element and/or the second transport element is/are also moved relative to the transport surface while receiving individual products from the conveying unit and/or while transferring individual products to the cassette.

10. The method according to claim 7, wherein individual products conveyed to two or more receiving positions are received, wherein a cassette is positioned at each of the receiving positions, and wherein the cassettes are moved by a first transport element movable relative to a transport surface while and/or after receiving the individual products.

11. The method according to claim 7, wherein two or more transport elements of the transport system are moved relative to one another, so that a group of individual products is compressed.

12. The method according to claim 7, wherein the cassette is moved while receiving individual products in such a way that the individual products are received in two or more horizontal planes.
